(19) United States
(12) Patent Application Publication
(10) Pub. No.: US 2025/0323548 A1
(43) Pub. Date: Oct. 16, 2025

(54) MOTOR

(71) Applicant: SANYO DENKI CO., LTD., Tokyo (JP)

(72) Inventor: Toshiaki AYUZAWA, Tokyo (JP)

(21) Appl. No.: 19/097,979

(22) Filed: Apr. 2, 2025

(30) Foreign Application Priority Data
Apr. 12, 2024 (JP) 2024-064970
Sep. 25, 2024 (JP) 2024-166052

(51) Int. Cl. H02K 3/52; H02K 11/22; H02K 21/16

(52) U.S. Cl. CPC H02K 3/522; H02K 11/22; H02K 21/16

(57) ABSTRACT

Provided is a motor including a housing forming an accommodation chamber where a stator is accommodated, in which the housing includes a partition wall that separates the accommodation chamber and an outside, the stator is electrically connected to a terminal portion, at least a part of the terminal portion is exposed in a hole portion provided in the partition wall, the accommodation chamber is blocked by a sealing cap being an insulator, in the hole portion, and the terminal portion is configured to be connected, on the outside, to a power line that supplies power to the stator.

### CROSS-REFERENCE TO RELATED APPLICATION

This application is based on Japanese Patent Application No. 2024-064970 filed with the Japan Patent Office on Apr. 12, 2024, and on Japanese Patent Application No. 2024-166052 filed with the Japan Patent Office on Sep. 25, 2024, the entire contents of which are hereby incorporated by reference.

### BACKGROUND

### 1. Technical Field

The present disclosure relates to a motor.

### 2. Related Art

JP-UM-A-8-727 discloses a leak-proof motor. This motor enhances liquid tightness with an oil seal.

### SUMMARY

A motor according to the present embodiment includes a housing forming an accommodation chamber where a stator is accommodated, in which the housing includes a partition wall that separates the accommodation chamber and an outside, the stator is electrically connected to a terminal portion, at least a part of the terminal portion is exposed in a hole portion provided in the partition wall, the accommodation chamber is blocked by a sealing cap being an insulator, in the hole portion, and the terminal portion is configured to be connected, on the outside, to a power line that supplies power to the stator.

### BRIEF DESCRIPTION OF DRAWINGS

FIG. 1 is a perspective view illustrating an example of a motor according to the embodiment;

FIG. 2 is a cross-sectional view of the motor according to the embodiment on arrows II-II illustrated in FIG. 1;

FIG. 3 is a diagram illustrating a sealing cap used for the motor according to the embodiment;

FIG. 4 is a cross-sectional view on arrows IV-IV in FIG. 1;

FIG. 5 is a partial cross-sectional view illustrating another example of the motor according to the embodiment, as viewed in the same direction as FIG. 2; and

FIG. 6 is a perspective view illustrating the other example of the motor according to the embodiment.

### DETAILED DESCRIPTION

In the following detailed description, for purpose of explanation, numerous

specific details are set forth in order to provide a thorough understanding of the disclosed embodiments. It will be apparent, however, that one or more embodiments may be practiced without these specific details. In other instances, well-known structures and devices are schematically shown in order to simplify the drawing.

In the configuration of a generally known motor, a power line is pulled out from inside the motor through a hole provided in a motor housing. The hole is then blocked with a sealing cap. However, the sealing cap tends to come out of the hole. Hence, there is room for improvement in workability.

An object of the present disclosure is to provide a motor that can enhance assembling workability.

A motor according to an aspect of the present disclosure includes a housing forming an accommodation chamber where a stator is accommodated, in which the housing includes a partition wall that separates the accommodation chamber and an outside, the stator is electrically connected to a terminal portion, at least a part of the terminal portion is exposed in a hole portion provided in the partition wall, the accommodation chamber is blocked by a sealing cap being an insulator, in the hole portion, and the terminal portion is configured to be connected, on the outside, to a power line that supplies power to the stator.

According to the above configuration, it is possible to provide a motor that can enhance assembling workability.

Specific examples of a motor according to the embodiment are described below with reference to the drawings. Note that the embodiment is not limited to these exemplifications. It is intended that the scope of the embodiment includes all modifications within the scope indicated by the claims and within the meaning and scope that are equivalent to the claims.

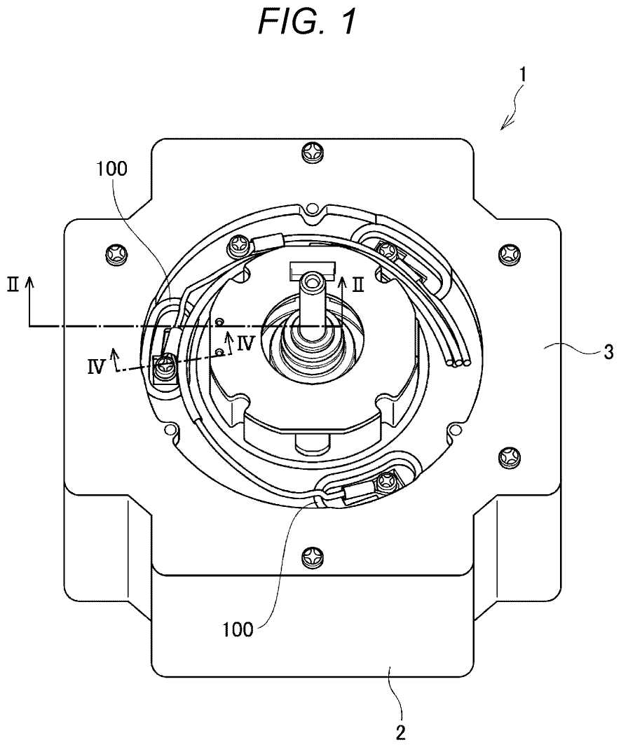

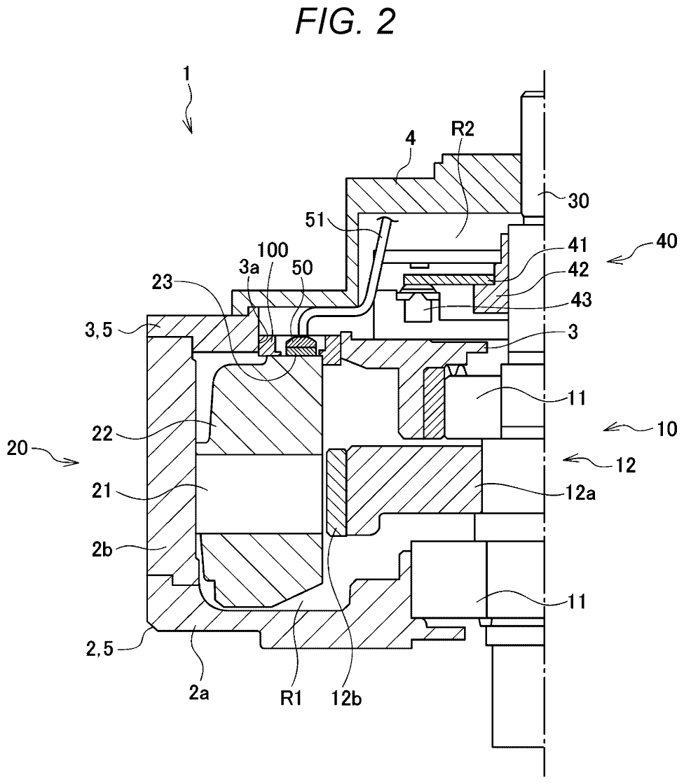

FIG. 1 is a perspective view illustrating an example of a motor 1 according to the embodiment. Moreover, FIG. 2 is a cross-sectional view of the motor 1 according to the embodiment as viewed on arrows taken along line II-II illustrated in FIG. 1. In the embodiment, an inner rotor brushless motor is described as the motor 1. As illustrated in FIGS. 1 and 2, the motor 1 includes a rotor 10, a stator 20, a frame 2, a bracket 3, a cover 4, an encoder 40, a terminal portion 50, and a sealing cap 100.

The frame 2 and the bracket 3 are members forming a main body outer portion of the motor 1. The frame 2 includes a flange portion 2a and a rectangular tube portion 2b that is attached to the flange portion 2a. A lower part of an internal space of the rectangular tube portion 2b is blocked by the flange portion 2a on the page of FIG. 2. Consequently, the frame 2 is open upward on the page of FIG. 2. The bracket 3 is provided in such a manner as to block the opening of the frame 2. The frame 2 and the bracket 3 form a motor housing 5. The motor housing 5 includes an accommodation chamber R1 therein. The rotor 10 described below and the stator 20 can be accommodated in the accommodation chamber R1. The bracket 3 functions as a partition wall that separates the accommodation chamber R1 and the outside. Note that in the example illustrated in FIG. 2, the frame 2 includes two components: the flange portion 2a and the rectangular tube portion 2b. However, the frame 2 may include many (three or more) components. Alternatively, the frame 2 may include a single component being a combination of the flange portion 2a and the rectangular tube portion 2b.

The rotor 10 is supported by the frame 2 via a bearing 11 in such a manner as to be rotatable about the axis of rotation. The rotor 10 includes a shaft 30, a rotor magnet 12b, and a yoke 12a. The shaft 30 is a shaft-shaped member extending in a direction of the axis of rotation. The rotor magnet 12b and the yoke 12a are provided to an outer peripheral portion of the shaft 30.

The stator 20 includes a core 21. The core 21 is formed of a plurality of laminated electromagnetic steel plates. A coil (not illustrated) is wound on the core 21. An end portion 23 of the coil wound on the core 21 is exposed to the outside at an end of the stator 20 in an axial direction thereof. In this state, the core 21 is sealed with a sealing compound. A part covered with the sealing compound is referred to hereinafter as a molded portion 22. In the embodiment, for example, an insulating thermosetting resin is used as the sealing compound for the molded portion 22. The molded portion 22 has an approximately cylindrical shape extending along the axis of rotation.

The encoder 40 can detect the angle of rotation of the rotor 10 relative to the stator 20. The encoder 40 includes an encoder disk 41, a hub 42, and a sensor unit 43. The hub 42 is fixed to the shaft 30. The encoder disk 41 is fixed to the hub 42 and rotates integrally with the shaft 30. The encoder disk 41 is provided with an optical pattern such as slits. The sensor unit 43 reads, for example, transmitted or reflected light of light that is applied through or to the optical pattern. Consequently, the angle of rotation of the rotor 10 relative to the stator 20 is detected. The encoder 40 is not limited to an optical encoder, but may be a magnetic encoder. The encoder 40 is provided outside the accommodation chamber R1 delimited by the frame 2 and the bracket 3. Note that the encoder 40 is protected by the cover 4 attached to the bracket 3. In the embodiment, the encoder 40 is provided inside an encoder chamber R2 formed by the cover 4 and the bracket 3.

The terminal portion 50 is electrically connected to the end portion 23 of the coil at the end of the stator 20 in the axial direction. The terminal portion 50 is connected to a power line 51 for supplying power. In the embodiment, the terminal portion 50 and the power line 51 are electrically connected by a solderless terminal 52 (refer to FIG. 4).

As illustrated in FIG. 2, the bracket 3 separates the accommodation chamber R1 provided with the bearing 11 and the encoder chamber R2 provided with the encoder 40. The bearing 11 includes lubricating oil to maintain the rolling characteristics of a rolling element excellent. When the lubricating oil adheres to the encoder 40 being a precision apparatus, the performance of the encoder 40 may decrease. In the example illustrated in FIG. 2, the bracket 3 separates the accommodation chamber R1 and the encoder chamber R2 to prevent the deterioration of the performance of the encoder 40.

However, the power line 51 located in the encoder chamber R2 needs to supply power to the stator 20 in the accommodation chamber R1. Hence, in the motor 1 according to the embodiment, the bracket 3 is provided with a hole portion 3a that exposes the terminal portion 50 electrically connected to the stator 20. Moreover, the sealing cap 100 being an insulator is fitted in the hole portion 3a. The sealing cap prevents the ingress of the lubricating oil into the encoder chamber R2 through the hole portion 3a.

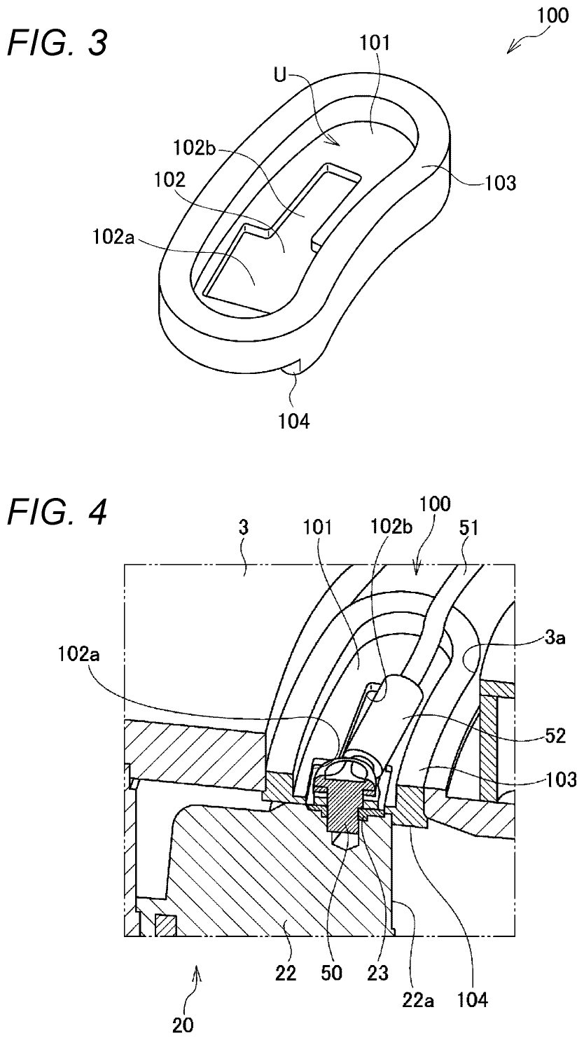

The hole portion 3a is a curved, long hole-shaped through-hole extending in a circumferential direction as viewed from above. As illustrated in FIG. 1, the sealing cap 100 has a shape fitting the hole portion 3a to be capable of fitting in the hole portion 3a. FIG. 3 is a perspective view of the sealing cap 100. As illustrated in FIG. 3, the sealing cap 100 is constructed in a shape of an approximately bath tub shape having an indentation U in the center. The sealing cap 100 includes a bottom portion 101 forming a bottom surface of the indentation U, an opening portion 102 provided in the bottom portion 101, an edge portion 103, and a protruding portion 104. The edge portion 103 extends from the bottom portion 101 and forms an outer peripheral surface of the indentation U. The protruding portion 104 extends from at least a part of the bottom portion 101 in a direction opposite to the edge portion 103. The opening portion 102 includes a first opening portion 102a and a second opening portion 102b. The second opening portion 102b extends from the first opening portion 102a along a longitudinal direction of the sealing cap 100. The first opening portion 102a is simply required to at least have a size and shape that allows the terminal portion 50 to be inserted therethrough.

FIG. 4 is a cross-sectional view on arrows IV-IV in FIG. 1. FIG. 4 is a diagram illustrating a state where the sealing cap 100 used in the embodiment is fitted in the hole portion 3a. As illustrated in FIG. 4, the sealing cap 100 is configured in such a manner as to be capable of fitting in the hole portion 3a provided to the bracket 3 without gaps. The first opening portion 102a is provided in such a manner as to be located directly above the end portion 23 when the sealing cap 100 is fitted in the hole portion 3a. At this point in time, the bottom portion 101 of the sealing cap 100 is in contact with the molded portion 22. The edge portion 103 is in contact with an inner peripheral surface of the hole portion 3a. Moreover, a rim portion of the first opening portion 102a provided in the bottom portion 101 is in contact with the molded portion 22 without gaps.

Moreover, a bottom surface of the sealing cap 100 is provided with the protruding portion 104. The protruding portion 104 protrudes from the bottom surface of the sealing cap 100 toward the accommodation chamber R1 along an inner peripheral surface 22a of the molded portion 22. In this manner, the protruding portion 104 is in contact with the inner peripheral surface 22a of the molded portion 22 without gaps. In the illustrated example, a distance between a radially inner part of the terminal portion 50 and a radially inner part of the molded portion 22 is short. Hence, the lubricating oil that adheres to the inner peripheral surface of the molded portion 22 may enter the encoder chamber R2 along a gap between the terminal portion 50 and the molded portion 22. Hence, the sealing cap 100 is provided with the protruding portion 104 extending along the inner peripheral surface 22a of the molded portion 22. Consequently, the area of contact between the sealing cap 100 and the molded portion 22 is secured. As a result, the ingress of the lubricating oil is prevented.

In the illustrated example, the terminal portion 50 is a screw component. The terminal portion 50 is screwed into a threaded hole in the end portion 23. Consequently, the terminal portion 50 is fixed to the end portion 23. As a result, a head of the terminal portion 50 and the end portion 23 sandwich the solderless terminal 52. Consequently, the solderless terminal 52 is fixed to the terminal portion 50. Consequently, the power line 51 brings the stator 20 into conduction. The second opening portion 102b of the sealing cap 100 has a size that allows a shaft of the solderless terminal 52 to be accommodated. The shaft of the solderless terminal 52 is located in the second opening portion 102b. Consequently, the movement of the solderless terminal 52 is prevented.

After the power line 51 is connected to the terminal portion 50, for example, molten resin is poured into the indentation U of the sealing cap 100. Consequently, the connection portion between the terminal portion 50 and the power line 51 is sealed. Consequently, the connection of the terminal portion 50 is protected.

In a generally known motor configuration, a power line is pulled out to the outside from an accommodation chamber where a rotor and a stator are accommodated. Hence, a hole is provided in a part of the accommodation chamber. In this structure, the hole is configured in such a manner as to be blocked with a sealing cap after the power line is pulled out. Consequently, the lubricating oil that is used for a bearing and flows out to the outside through the hole is prevented from adhering to a precision component such as an encoder disk. However, in this configuration, when the power line connected to a terminal moves, the sealing cap may come out. Hence, a motor assembly worker needs to assemble the motor, taking care not to let the sealing cap come out. Hence, assembling workability is low.

In the motor 1 according to the embodiment, at least a part of the terminal portion 50 is exposed from the sealing cap 100. In addition, outside the sealing cap 100, the power line 51 that supplies power to the stator 20 is connected to the terminal portion 50. According to this configuration, the terminal portion 50 exposed from the sealing cap 100 is connected to the power line 51, outside the sealing cap 100. Hence, even if the power line 51 moves, the sealing cap 100 does not move. Consequently, the sealing cap 100 resists coming out as compared to the general configuration. Hence, it is possible to provide a motor with high assembling workability.

Moreover, in the motor 1 according to the embodiment, the sealing cap may be sandwiched between the power line and the partition wall (the bracket 3). According to the above configuration, the sealing cap further resists coming out.

Moreover, in the motor 1 according to the embodiment, the sealing cap 100 includes the indentation U. In the configuration of the motor 1, the connection spot between the terminal portion 50 and the power line 51 may be sealed with resin in the indentation U. According to the above configuration, the resin protects the connection spot. Furthermore, the terminal portion 50 and the power line 51 resist moving relative to the sealing cap 100. Consequently, the sealing cap resists coming out. Hence, it is possible to provide a motor with high assembling workability.

Moreover, in the motor 1 according to the embodiment, the indentation U may extend in a direction in which the power line 51 extends. Consequently, it is possible to prevent interference between the power line 51 and the sealing cap 100.

Moreover, in the motor 1 according to the embodiment, the power line 51 may be connected to the terminal portion 50 by the solderless terminal 52 (FIG. 4). In this case, the indentation U extends in a direction in which the solderless terminal 52 extends. Consequently, it is possible to prevent interference between the solderless terminal 52 and the sealing cap 100.

Moreover, in the motor 1 according to the embodiment, the partition wall (the bracket 3) may be configured in such a manner as to separate the accommodation chamber R1 and the encoder chamber R2 where the encoder 40 is accommodated. Consequently, it is possible to prevent the oil leaking out of the bearing from adhering to the encoder 40.

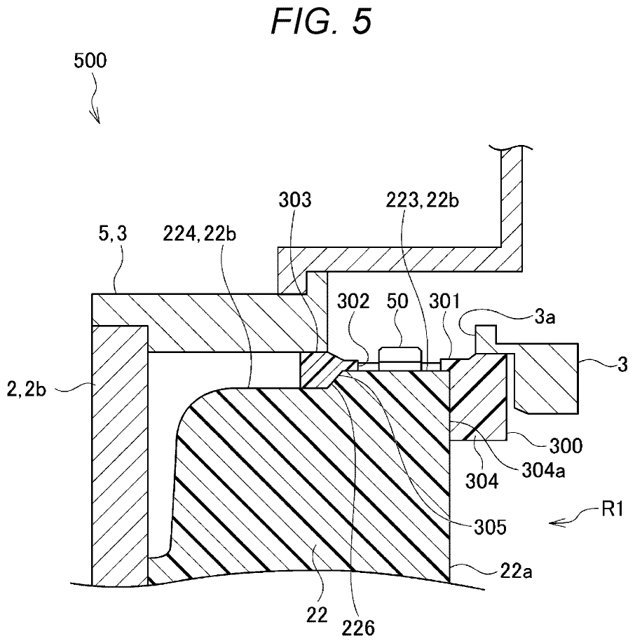

Up to this point the embodiment has been described. The configuration of the motor according to the embodiment is not limited to the above-mentioned configuration. A motor according to another embodiment of the present disclosure is described with reference to FIG. 5. FIG. 5 illustrates a motor 500 according to the other embodiment of the present disclosure. FIG. 5 is a partial cross-sectional view of the motor 500 as viewed in the same direction as FIG. 2. Note that the same reference numerals are used for the same members as those of the embodiment illustrated in FIGS. 1 to 4. In addition, descriptions thereof are omitted.

Also in the embodiment illustrated in FIG. 5, the frame 2 and the partition wall (the bracket 3) form the motor housing 5 as in the embodiment illustrated in FIG. 2. In addition, the molded portion 22 of the stator 20 is accommodated in a columnar space (the accommodation chamber R1) inside the motor housing 5. The molded portion 22 is provided with the terminal portion 50. An opening is provided which is open upward of the motor housing 5. The ring plate-shaped bracket 3 is fitted in the opening. The bracket 3 is provided with the hole portion 3a. In the embodiment illustrated in FIG. 5, the hole portion 3a provided to the bracket 3 is sealed with a sealing cap 300.

The sealing cap 300 includes a plate-shaped portion 301, an opening portion 302 provided in the plate-shaped portion 301, an outer edge portion 303, and an inner edge portion 304. The outer edge portion 303 is located radially outward of the plate-shaped portion 301. The inner edge portion 304 is located radially inward of the plate-shaped portion 301. The sealing cap 300 is provided in such a manner that the opening portion 302 is located directly above the terminal portion 50.

As illustrated in FIG. 5, the sealing cap 300 according to the other embodiment of the present disclosure is provided in such a manner as to be sandwiched between the molded portion 22 and the bracket 3. More specifically, the sealing cap 300 is provided in such a manner as to be located and sandwiched between the molded portion 22 and the bracket 3 in an axial direction of the motor 500. The outer edge portion 303 of the sealing cap 300 is provided in such a manner as to come into contact with a bottom surface of the bracket 3. Moreover, a lower surface 305 of the sealing cap 300 is provided in such a manner as to come into contact with an upper surface 22b of the molded portion 22.

The sealing cap 300 is sandwiched between the bracket 3 and the molded portion 22. Hence, a compressive force acts on the sealing cap 300 from each of the bracket 3 and the molded portion 22. Consequently, the sealing cap 300 is brought into intimate contact with the bracket 3 and the molded portion 22. Consequently, it is possible to prevent the oil from leaking out of the accommodation chamber R1.

It is preferable that the lower surface 305 of the sealing cap 300 be provided from the inner peripheral surface 22a to the upper surface 22b of the molded portion 22. For example, in the example illustrated in FIG. 5, the upper surface 22b of the molded portion 22 is divided into an inner peripheral portion 223 provided with the terminal portion 50 and an outer peripheral portion 224 without the terminal portion 50. It is preferable that the sealing cap 300 be provided in such a manner as to come into contact with the molded portion 22 from the inner peripheral surface 22a to the outer peripheral portion 224 of the molded portion 22. With the above configuration, the area of contact between the sealing cap 300 and the molded portion 22 increases. Hence, adhesion between the sealing cap 300 and the molded portion 22 can be increased.

Moreover, the lower surface 305 of the sealing cap 300 is in contact with the upper surface 22b of the molded portion 22. It is preferable that the lower surface 305 have a shape fitting an uneven shape of the upper surface 22b of the molded portion 22. For example, on the upper surface 22b of the molded portion 22 illustrated in FIG. 5, the inner peripheral portion 223 has a shape that is higher in the axial direction than the outer peripheral portion 224. In other words, an inclined surface 226 that becomes increasingly higher toward the inner diameter is formed between the inner peripheral portion 223 and the outer peripheral portion 224. As illustrated in FIG. 5, the lower surface 305 of the sealing cap 300 includes a portion that comes into contact with the inner peripheral portion 223, a portion that comes into contact with the inclined surface 226, and a portion that comes into contact with the outer peripheral portion 224 to fit the above-mentioned shape of the upper surface 22b of the molded portion 22. According to the above configuration, it is easy to place the sealing cap in position in a radial direction. In addition, it is easy to fix the sealing cap on the upper surface of the molded portion. Consequently, it is possible to provide a motor with high assembling workability.

Moreover, in the illustrated example, the outer edge portion 303 is a part that is thicker than the plate-shaped portion 301. The outer peripheral portion 224 of the upper surface 22b of the molded portion 22 is lower than the inner peripheral portion 223. Hence, a large gap is provided between the bracket 3 and the outer peripheral portion 224. The outer edge portion 303 fills this large gap. Hence, it is easy to prevent the leakage of the oil from the accommodation chamber R1.

Moreover, in the illustrated example, the inner edge portion 304 is a part that is thicker than the plate-shaped portion 301. An outer peripheral surface 304a of the inner edge portion 304 is in contact with the inner peripheral surface 22a of the molded portion 22. The sealing cap 300 includes the inner edge portion 304 and the part that comes into contact with the inclined surface 226. Hence, it is easier to come into intimate contact with the molded portion 22.

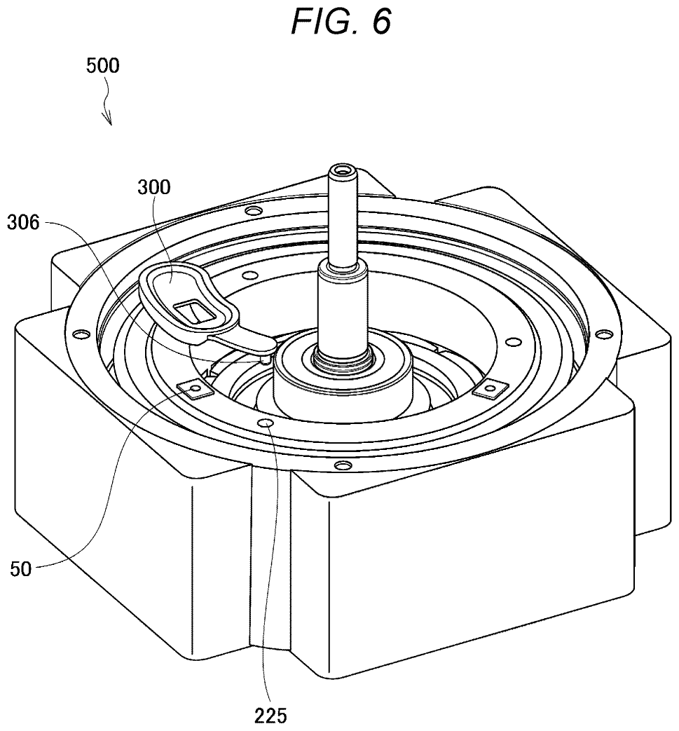

The sealing cap 300 according to the other embodiment of the present disclosure is described in detail with reference to FIG. 6. FIG. 6 is a perspective view illustrating the motor 500 according to the other embodiment of the present disclosure. FIG. 6 illustrates the motor 500 in the middle of assembly. The sealing cap 300 mounted on the terminal portion 50 provided to the molded portion 22 is illustrated. In the step of mounting the sealing cap 300 on the upper surface 22b of the molded portion 22, it is necessary to locate the opening portion 302 of the sealing cap 300 directly above the terminal portion 50 provided on the upper surface of the molded portion 22. Hence, the sealing cap 300 needs to be placed in position in a circumferential direction of the motor 500.

As illustrated in FIG. 6, the sealing cap 300 may be configured in such a manner as to include a positioning projection 306 that fits in an opening 225. The opening 225 is provided in the upper surface 22b of the molded portion 22 in the course of molding the molded portion 22. The sealing cap 300 illustrated in FIG. 6 is configured in such a manner that the opening portion 302 is located over the terminal portion 50 of the molded portion 22 after the positioning projection 306 is inserted into the opening 225. According to the configuration, it is possible to determine the position of the sealing cap 300 in the circumferential direction by simply inserting the positioning projection 306 into the opening 225. Consequently, it is possible to simplify the positioning of the sealing cap 300 in the circumferential direction of the motor 500.

Up to this point the embodiments have been described. However, the configurations of the embodiments are not limited to the above-mentioned embodiments. For example, the configurations of the embodiments can be applied to every machine having a rotary mechanism including a rotor supported by a bearing that uses lubricating oil.

The embodiment has been described above. However, it goes without saying that the technical scope of the embodiments should not be interpreted as limited by the description of the embodiments. The embodiments described are merely examples. It is understood by those skilled in the art that various forms of modifications to the described embodiments are possible within the scope of the disclosure of the claims. The technical scope of the embodiments should be determined based on the scope of the disclosure of the claims and its equivalents.

The foregoing detailed description has been presented for the purposes of illustration and description. Many modifications and variations are possible in light of the above teaching. It is not intended to be exhaustive or to limit the subject matter described herein to the precise form disclosed. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims appended hereto.

What is claimed is:

1. A motor comprising a housing forming an accommodation chamber where a stator is accommodated, wherein
the housing includes a partition wall that separates the accommodation chamber and an outside,
the stator is electrically connected to a terminal portion,
at least a part of the terminal portion is exposed in a hole portion provided in the partition wall,
the accommodation chamber is blocked by a sealing cap being an insulator, in the hole portion, and
the terminal portion is configured to be connected, on the outside, to a power line that supplies power to the stator.

2. The motor according to claim 1, wherein the sealing cap is configured to be sandwiched between the power line and the partition wall.

3. The motor according to claim 1, wherein
the sealing cap includes an indentation, and
the motor is configured in such a manner that the connection spot between the terminal portion and the power line is sealed with resin in the indentation.

4. The motor according to claim 3, wherein the indentation extends in a direction in which the power line extends.

5. The motor according to claim 1, wherein the partition wall separates the accommodation chamber and an encoder chamber where an encoder is accommodated.

6. The motor according to claim 1, wherein the sealing cap is fitted in the hole portion.

7. The motor according to claim 1, wherein the sealing cap is sandwiched between a resin molded portion that seals the stator, and the partition wall.

8. The motor according to claim 7, wherein the sealing cap is located between the molded portion and the partition wall in an axial direction of the motor.

9. The motor according to claim 7, wherein
the terminal portion is provided to an inner peripheral portion of an upper surface of the molded portion, and
the sealing cap is in contact with the molded portion from an inner peripheral surface of the molded portion to an outer peripheral portion of the upper surface of the molded portion.

10. The motor according to claim 7, wherein in a cross section of the motor including a plane, which extends in an axial direction and a radial direction, of the motor, a lower surface of the sealing cap has a shape fitting an uneven shape of the upper surface of the molded portion.

11. The motor according to claim 10, wherein
the sealing cap includes a positioning projection, and
the positioning projection is inserted in an opening provided in the upper surface of the molded portion.

12. The motor according to claim 11, wherein the opening is a trace of a holding pin that extends from an outside of a mold in such a manner as to hold a board down upon insert molding of the stator.
